(19) United States
(12) Patent Application Publication
(10) Pub. No.: US 2021/0042519 A1
(43) Pub. Date: Feb. 11, 2021

(54) METHOD FOR EVALUATING VIBRATING SENSATION SIMILARITY, APPARATUS AND STORAGE MEDIUM

(71) Applicant: AAC Technologies Pte. Ltd., Singapore city (SG)

(72) Inventors: Zheng Xiang, Shenzhen (CN); Xiuyue Wang, Shenzhen (CN)

(21) Appl. No.: 16/992,152

(22) Filed: Aug. 13, 2020

Related U.S. Application Data
(63) Continuation of application No. PCT/CN2019/100052, filed on Aug. 9, 2019.

(30) Foreign Application Priority Data
Aug. 7, 2019 (CN) 201910727391.X

(51) Int. Cl. G06K 9/00; G01P 15/00; G01H 11/00; G06F 3/01

(52) U.S. Cl. CPC G06K 9/00543; G01P 15/00; G06F 3/016; G06K 9/0053; G01H 11/00

(57) ABSTRACT

A method for evaluating a vibrating sensation similarity may generally include acquiring waveforms of two acceleration signals and waveforms of two excitation signals corresponding to the two acceleration signals, respectively; and, based on the waveforms of the two acceleration signals and the waveforms of the corresponding excitation signals, calculating a similarity between the waveforms of the two acceleration signals by a method for calculating an acceleration similarity to thereby evaluate a vibrating sensation similarity of devices corresponding to the two acceleration signals according to the similarity between the waveforms of the two acceleration signals. The method for calculating an acceleration similarity may include a method for calculating a similarity between the two acceleration signals from the perspective of numerical values and/or a method for calculating a similarity between the two acceleration signals from the perspective of user experience.

### TECHNICAL FIELD

The present disclosure relates to calculation of waveform similarities, and in particular, to a method for evaluating a vibrating sensation similarity, an apparatus and a storage medium.

### BACKGROUND

At present, vibration feedback applied in scenarios such as mobile phone interactions, shooting games, and boxing games provides users with a good immersive experience. Therefore, more and more electronic products are imposing increasingly higher requirements on a similarity of vibration feedback. How to produce the consistent vibration feedback in different devices has thus become an increasingly urgent need.

Therefore, in order to provide the same vibration feedback experience to users, it is necessary to provide a method for evaluating a vibrating sensation similarity.

### SUMMARY

In one aspect, a method for evaluating a vibrating sensation similarity is provided which is capable of quantification of vibrating sensation similarity for intuitively reflecting the user's subjective vibrating sensation. The method may generally include acquiring waveforms of two acceleration signals and waveforms of two excitation signals corresponding to the two acceleration signals, respectively; and, based on the waveforms of the two acceleration signals and the waveforms of the corresponding excitation signals, calculating a similarity between the waveforms of the two acceleration signals by a method for calculating an acceleration similarity to thereby evaluate a vibrating sensation similarity of devices corresponding to the two acceleration signals according to the similarity between the waveforms of the two acceleration signals. The method for calculating an acceleration similarity may include a method for calculating a similarity between the two acceleration signals from the perspective of numerical values and/or a method for calculating a similarity between the two acceleration signals from the perspective of user experience.

In one embodiment, the method of calculating a similarity between the two acceleration signals from the perspective of user experience may include setting indexes; calculating a similarity between the two acceleration signals according to each index; and calculating a similarity between the two acceleration signals corresponding to all indexes using a weighted average method.

In one embodiment, the indexes may include a difference in peak-to-peak values of acceleration in a signal phase, a difference in peak-to-peak values of acceleration in a residual vibration phase, a difference in signal duration, and a difference in the number of peak values in the signal phase.

In one embodiment, calculating the similarity between the two acceleration signals according to all indexes may include, when the index is the difference in peak-to-peak values of acceleration in the signal phase, calculating a similarity between peak-to-peak values of the two acceleration waveforms in a signal phase of the excitation signal; and when the index is the difference in peak-to-peak values of acceleration in the residual vibration phase, calculating a similarity between peak-to-peak values of the acceleration waveforms after the excitation signal ends.

In one embodiment, calculating the similarity between the two acceleration signals according to all indexes may further include, when the index is the difference in signal duration, calculating a similarity between durations of the excitation signals of the two acceleration waveforms; and when the index is the difference in the number of peak values in the signal phase, calculating a similarity between the numbers of local peak values of acceleration signals of the two acceleration waveforms.

In one embodiment, the method of calculating a similarity between the two acceleration signals from the perspective of numerical values may include calculating the similarity between the two acceleration signals according to a method of calculating the similarity between two curves.

In one embodiment, the method of calculating the similarity between two curves may include one of an EVM-based method, a Minkowski-distance-based method and a Fletcher-similarity-based method. If the EVM-based method is used, a calculation formula for the EVM-based method may be as follows:

$$evm = \sqrt{\frac{{\sum }_{i = 1}^{n} {\vert {x}_{i} - {y}_{i} \vert}^{2}}{{\sum }_{i = 1}^{n} {\vert {x}_{i} \vert}^{2}}} \times 100 \% ,$$

where a similarity between the two curves is 1-evm.

In another independent aspect, an apparatus for evaluating a vibrating sensation similarity is provided. The apparatus may generally include at least one processor and a memory in communication with the at least one processor. The memory may store a similarity evaluation program thereon. The similarity evaluation program is executable by the at least one processor to implement a method for evaluating a vibrating sensation similarity. The method may generally include acquiring waveforms of two acceleration signals and waveforms of two excitation signals corresponding to the two acceleration signals, respectively; and based on the waveforms of the two acceleration signals and the waveforms of the corresponding excitation signals, calculating a similarity between the waveforms of the two acceleration signals by a method for calculating an acceleration similarity to thereby evaluate a vibrating sensation similarity of devices corresponding to the two acceleration signals according to the similarity between the waveforms of the two acceleration signals.

In some embodiments, the method for calculating an acceleration similarity may include a method for calculating a similarity between the two acceleration signals from the perspective of numerical values and/or a method for calculating a similarity between the two acceleration signals from the perspective of user experience.

In still another independent aspect, a computer-readable storage medium is provided which has a similarity evaluation program stored thereon. The similarity evaluation program is executable by a processor to implement a method for evaluating a vibrating sensation similarity. The method may generally include acquiring waveforms of two acceleration signals and waveforms of two excitation signals corresponding to the two acceleration signals, respectively; and based on the waveforms of the two acceleration signals and the waveforms of the corresponding excitation signals, calculating a similarity between the waveforms of the two acceleration signals by a method for calculating an acceleration similarity to thereby evaluate a vibrating sensation similarity of devices corresponding to the two acceleration signals according to the similarity between the waveforms of the two acceleration signals. In some embodiments, the method for calculating an acceleration similarity may include a method for calculating a similarity between the two acceleration signals from the perspective of numerical values and/or a method for calculating a similarity between the two acceleration signals from the perspective of user experience.

In summary, factors related to the user experience are taken into consideration in the calculation of the similarity between the acceleration waveforms, such that the resulted objective quantitative evaluation of the vibrating sensation similarity can be more consistent with the user's subjective vibrating sensation.

Independent features and/or independent advantages of this disclosure may become apparent to those skilled in the art upon review of the detailed description, claims and drawings.

### BRIEF DESCRIPTION OF THE DRAWINGS

In order to explain the technical solutions of the embodiments of the present disclosure more clearly, accompanying drawings used to describe the embodiments are briefly introduced below. It is evident that the drawings in the following description are only concerned with some embodiments of the present disclosure. For those skilled in the art, in a case where no inventive effort is made, other drawings may be obtained based on these drawings.

FIG. 1 is a waveform diagram of an excitation signal of acceleration acc1 according to one embodiment of the present disclosure;

FIG. 2 is waveform diagrams of accelerations acc1, acc2, acc3 according to one embodiment of the present disclosure;

FIG. 3 is a schematic diagram of a signal phase and a residual vibration phase of an excitation signal U according to one embodiment of the present disclosure;

FIG. 4 is a block diagram of acceleration detection hardware according to one embodiment of the present disclosure;

FIG. 5 is a flowchart of a method for evaluating a vibrating sensation similarity according to one embodiment of the present disclosure;

FIG. 6 is a flowchart of a method for calculating a similarity between acceleration signals from the perspective of user experience according to one embodiment of the present disclosure; and

FIG. 7 is a block diagram of an apparatus for evaluating a vibrating sensation similarity according to one embodiment of the present disclosure.

### DESCRIPTION OF THE EMBODIMENTS

The present disclosure will be further described below in conjunction with the drawings and embodiments.

In general, a quantification of evaluation of vibrating sensation similarity is realized by converting it into a calculation of a waveform similarity. That is, the vibrating sensation similarity evaluation is converted into the calculation of the waveform similarity.

Therefore, the present disclosure is directed to the calculation of the similarity between two waveforms, and a process of the calculation is explained in conjunction with the following examples.

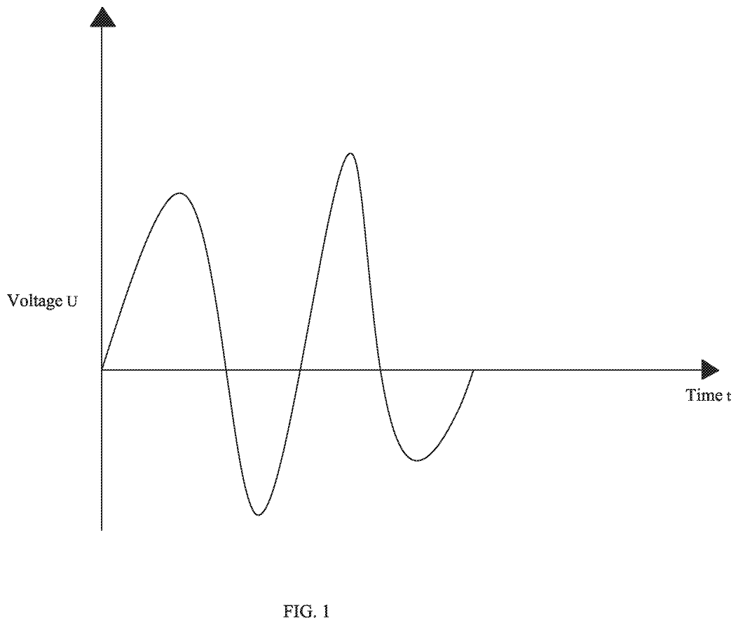

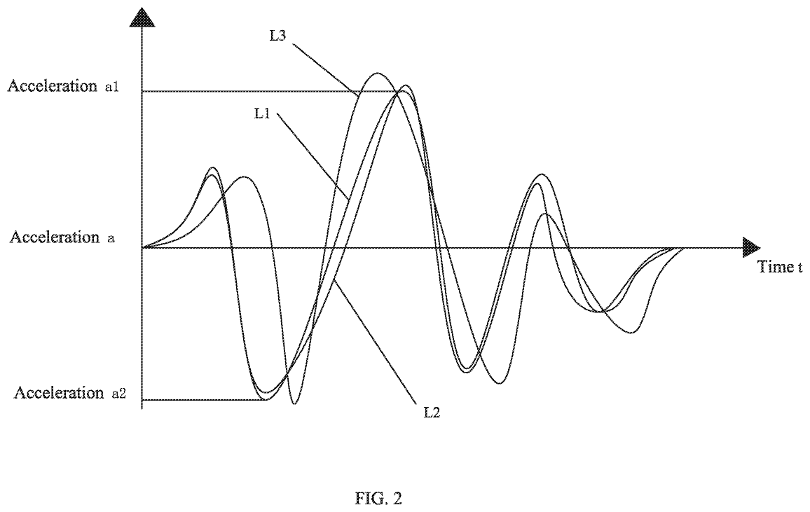

As shown in FIG. 1 and FIG. 2, acceleration acc1 has a waveform denoted by L1, and an excitation voltage corresponding to the acceleration acc1 has a waveform denoted by U1. Another two accelerations acc2 and acc3 have waveforms denoted by L2 and L3, respectively, and their corresponding excitation voltages have waveforms U2, U3 which are not shown in the Figures. Different accelerations are resulted by different excitation voltages. FIG. 1 is a waveform diagram showing the waveform of the excitation voltage U, and FIG. 2 is a waveform diagram showing the waveforms of the acceleration acc1, the acceleration acc2, and the acceleration acc3.

Taking the acceleration acc1 as a reference basis, it can be seen from FIG. 2 that the acceleration acc1 is very similar to the acceleration acc2, while the acceleration acc1 differs largely from the acceleration acc3, when viewed from the perspective of waveform shape.

For the calculation of waveform similarity, in general, traditional techniques usually use methods such as Error Vector Magnitude (EVM) to describe a similarity between two curves, that is, a similarity between two waveforms. For example, the EVM-based method is to calculate an error between data of the two waveforms point by point, and calculate a ratio of the error to a reference signal (such as the acceleration acc1).

For example, an EVM calculation formula for a signal x and a signal y is as follows:

$$evm = \sqrt{\frac{{\sum }_{i = 1}^{n} {\vert {x}_{i} - {y}_{i} \vert}^{2}}{{\sum }_{i = 1}^{n} {\vert {x}_{i} \vert}^{2}}} \times 100 \% . \qquad ( 1 )$$

With the formula (1), it can be obtained by calculation that a similarity between the acceleration acc1 and the acceleration acc2 is 92%, and that a similarity between the acceleration acc1 and the acceleration acc3 is 60%.

As can be seen from the above, when a similarity between the waveforms is calculated through the EVM-based method, the calculation method is purely based on signal processing, which calculates the similarity between the two waveforms merely from the perspective of numerical values and does not take the physical meaning of the curve into consideration.

However, in judging the vibrating sensation similarity, vibrating sensation is not only related to numerical values, but it also related to human. That is, all factors such as different phases and duration associated with the curve will affect users' vibrating sensation. As a result, the EVM-based method cannot describe the similarity between waveforms from the perspective of user experience.

Therefore, the present disclosure provides a method for evaluating a vibrating sensation similarity, which evaluates the vibrating sensation similarity by taking into account both the numerical value and human perspectives from which the similarity between the waveforms is described. In actual implementation, a corresponding perspective can be selected according to the actual application scenario, from which the similarity between two waveforms is calculated to thereby evaluate the similarity of the user's subjective vibrating sensation. Calculating the similarity between the two waveforms from the perspective of numerical value is to set an index for calculating the similarity from the perspective of pure signal processing, the index being regarded as an upper border indicative of an upper limit of an allowable range for the similarity.

Calculating the similarity between the two waveforms from the perspective of user experience is to set an index for calculating the similarity between acceleration waveforms from the perspective of user experience, is the index being regarded as a lower border indicative of a lower limit of an allowable range for the similarity.

For example, the similarity between the acceleration acc1 and the acceleration acc2, and the similarity between the acceleration acc1 and the acceleration acc3 are each calculated by the method for calculating a waveform similarity provided herein, respectively. The specific calculation is described as follows.

1. The upper border of the acceleration waveform similarity

The upper border refers to the similarity between the two acceleration waveforms that is calculated from the perspective of numerical value. Therefore, for the purpose of calculating the upper border, the similarity between two curves can be calculated using the EVM-based method as described above.

As mentioned previously, the similarity between the acceleration acc1 and the acceleration acc2 is 92%, and the similarity between acc1 and acc3 is 60%.

In addition, the calculation of the similarity between the two acceleration waveforms from the perspective of numerical value can also be implemented by other similar methods such as a Minkowski-distance-based method or a Fletcher-similarity-based method. These methods are well known to those skilled in the art and therefore are not explained herein in detail.

2. The lower border of the acceleration waveform similarity

The lower border refers to the similarity between two waveforms that is calculated from the perspective of user experience.

Embodiments of the present disclosure derive the user experience based on practical experience, and introduce factors related to the user experience, such as a vibration strength, a tailing strength, a vibrating sensation duration, and a vibrating sensation frequency, into the calculation of the acceleration waveform similarity.

As shown in Table 1, indexes for calculating the acceleration waveform similarity are set correspondingly for the factors related to the user experience, such as the vibration strength, the tailing strength, the vibrating sensation duration, and the vibrating sensation frequency.

TABLE 1

| No. | Index (100%) | User experience |
|---|---|---|
| 1 | Difference in peak-to-peak values of acceleration in signal phase | Vibration strength |
| 2 | Difference in peak-to-peak values of acceleration in residual | Tailing strength |
| | vibration phase | |
| 3 | Difference in signal duration | Vibrating sensation duration |
| 4 | Difference in the number of peak values in signal phase | Vibrating sensation frequency |

That is to say, in calculating the acceleration waveform similarity, the acceleration waveform similarity is calculated with respect to these indexes, respectively. Because these indexes are related to the user experience, the acceleration waveform similarity calculated with respect to these indexes can better reflect the similarity of user's vibrating sensations.

A process of calculating the acceleration waveform similarity based on the above indexes is described in detail as follows.

(1) Difference in peak-to-peak values of acceleration (peak-to-peak values of acceleration, the peak-to-peak value G is called Gpp for short) in signal phase

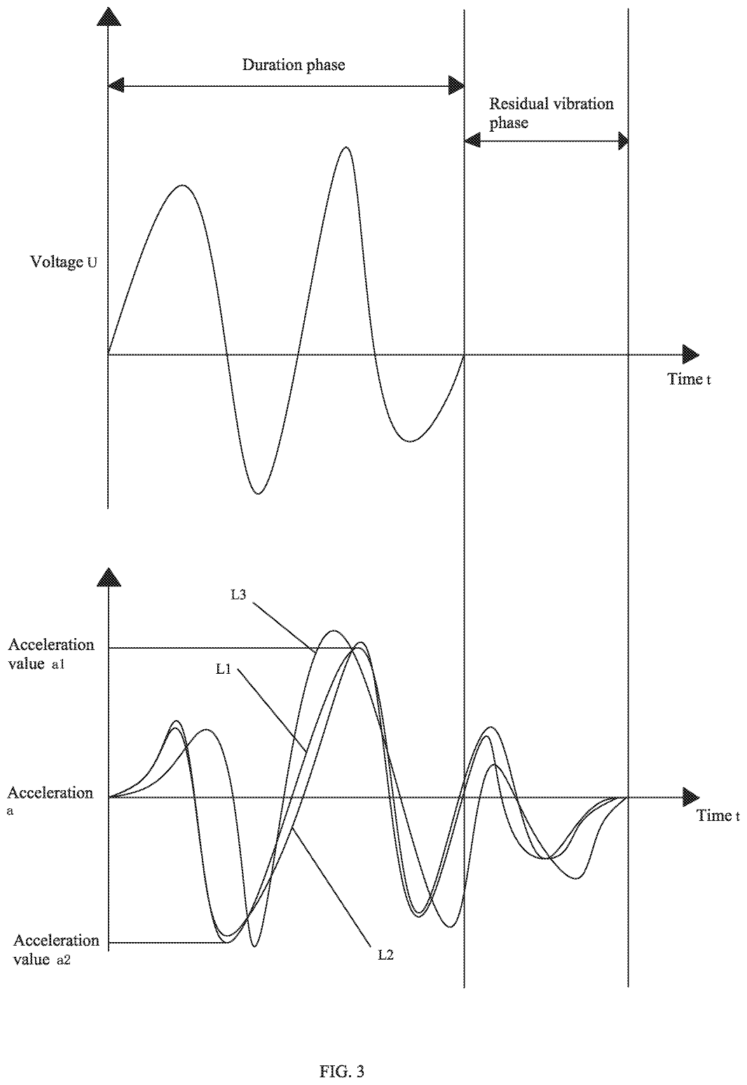

FIG. 3 depicts the signal phase and the residual vibration phase of the excitation signal U. The excitation signal for each acceleration can be divided into a signal phase (i.e. the phase during which the excitation signal excites the motor, also termed as a “duration phase” in this disclosure) and a residual vibration phase.

As defined in the present disclosure, the difference in peak-to-peak values of acceleration in the signal phase refers to a difference in the peak-to-peak values of the corresponding acceleration waveform in the signal phase of the excitation signal for each acceleration. When the peak-to-peak values of different acceleration waveforms are different, corresponding vibrating sensation strengths of the user experience are also different. Therefore, the similarity between two acceleration waveforms is calculated by calculating the similarity between the peak-to-peak values of the acceleration waveforms of the two accelerations in the signal phase of the respective excitation signals. The peak-to-peak value Gpp refers to the value of the difference between the highest value and the lowest value of the signal within one cycle, that is, the range between the maximum value and the minimum value.

For example, assuming Gpp1 for acceleration acc1=3, Gpp2 for acc2=2.8, and Gpp3 for acc3=3.1, then
the similarity between acc1 and acc2 with respect to the difference in peak-to-peak values of acceleration in the signal phase is:

(1−abs(3−2.8)/3)*100%;
and the similarity between acc1 and acc3 with respect to the difference in peak-to-peak values of acceleration in the signal phase is:

(1−abs(3−3.1)/3)*100%.

That is, the similarity between the acceleration acc1 and the acceleration acc2 is 98%, and the similarity between acc1 and acc3 is 94%.

(2) Difference in peak-to-peak values of acceleration in residual vibration phase

In general, after an excitation signal for exciting a device such as a motor ends, a residual vibration of the motor occurs at its own resonance frequency. Therefore, the residual vibration phase of the excitation signal also has effects on the user's vibrating sensation, such as the strength of the trailing vibration. After the excitation signal ends, that is, in the residual vibration phase, the similarity between two acceleration waveforms is likewise calculated according to the similarity between the peak-to-peak values of two acceleration waveforms.

For example, as calculated by the method for calculating the acceleration waveform similarity based on the difference in peak-to-peak values of acceleration in the signal phase, with respect to the difference in peak-to-peak values of acceleration in the residual vibration phase, the similarity between the acceleration acc1 and the acceleration acc2 is 92%, and the similarity between the acceleration acc1 and the acceleration acc3 is 83%.

(3) Difference in signal duration

The length of duration of the signal also has effects on the user's vibrating sensation, such as the vibrating sensation duration. The signal duration here refers to the signal duration of the excitation signal corresponding to each acceleration. Therefore, the similarity between two acceleration waveforms is indicated by calculating the similarity between the signal durations of the excitation signals. That is, the similarity between two accelerations is calculated according to the lengths of durations of the excitation signals of the two accelerations.

For example, with respect to the difference in signal duration of the excitation signals, the similarity between the acceleration acc1 and the acceleration acc2 is 84%, and the similarity between the acceleration acc1 and the acceleration acc3 is 88%.

(4) Difference in the number of peak values in signal phase

The difference in the number of the peak values of acceleration also has effects on the vibrating sensation, such as the vibrating sensation strength. The number of local peak values of the acceleration signal refers to the number of peak values in the acceleration in the signal phase of the excitation signal. Therefore, the similarity between two accelerations is calculated based on the difference in the number of peak values in the signal phase of the excitation signal.

For example, with respect to the difference in the number of peak values in the signal phase, the similarity between the acceleration acc1 and the acceleration acc2 is 100%, and the similarity between the acceleration acc1 and the acceleration acc3 is 100%.

In order to make scalars of vibrating sensations of the above indexes consistent, the similarities between the two acceleration waveforms calculated with respect to the above four indexes need to be processed by, for example, a weighted average method, to obtain the lower boarder of the acceleration waveform similarity.

For example, in this embodiment, the simplest average method is used for processing the similarity results for the above four indexes, as follows.

The similarity between the acceleration acc1 and the acceleration acc2 is:

(98%+92%+84%+100%)/4=93.5%.

The similarity between the acceleration acc1 and the acceleration acc3 is:

(94%+83%+88%+100%)/4=91.2%.

That is, as calculated from the perspective of user experience, the similarity between the accelerations acc1 and acc2 is 93.5%, and the similarity between the accelerations acc1 and acc3 is 91.2%.

In summary, taking the acceleration acc1 as a reference basis:
from the perspective of waveform shape, the acceleration acc1 is relatively similar to the acceleration acc2, and the acceleration acc1 differs largely from the acceleration acc3;
from the perspective of numerical values (for example, the EVM method is used for calculation), the similarity between the acceleration acc1 and the acceleration acc2 is 92%, while the similarity between acc1 and acc3 is 60%; and
from the perspective of user experience, the similarity between the accelerations acc1 and acc2 is 93.5%, and the similarity between the accelerations acc1 and acc3 is 91.2%.

Obviously, although the calculation results for the acceleration 1 and the acceleration 3 from the waveform shape and numerical value perspectives show that the difference between the two is large, the similarity between the acceleration waveforms is relatively high when calculated from the perspective of user experience. Therefore, in evaluating the vibrating sensation similarity in actual application, different perspectives can be selected according to actual application scenarios to calculate the waveform similarity to realize the evaluation of the vibrating sensation similarity. As discussed above, evaluation of the vibrating sensation similarity is converted into the calculation of the similarity between the acceleration waveforms, and it can be seen from the above calculation results that, in the present disclosure, the calculation of the similarity between the acceleration waveforms from the perspective of user experience can result in an objective quantitative evaluation of the vibrating sensation similarity that can be more consistent with the user's subjective vibrating sensation.

That is, in evaluating the vibrating sensation similarity, the acceleration waveforms and their corresponding excitation signals are first acquired when two devices vibrate. It is then determined according to the actual application scenario whether to calculate the similarity between two acceleration waveforms based on the upper boarder of the waveform similarity or calculate the similarity between two acceleration waveforms based on the lower boarder of the waveform similarity. The vibrating sensation similarity is then evaluated according to the quantitative result of the calculation of the similarity between the two acceleration waveforms.

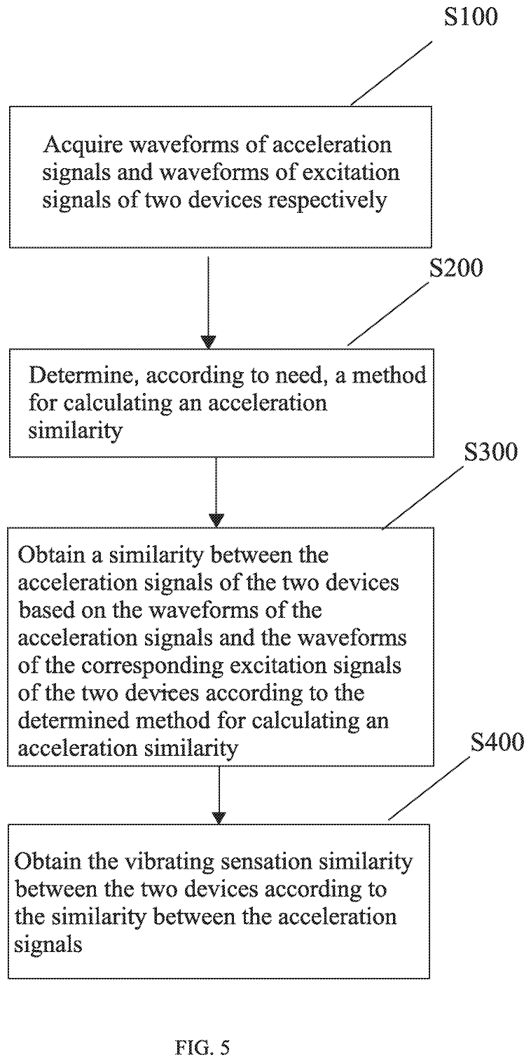

FIG. 5 illustrates a method for calculating a vibrating sensation similarity according to one embodiment. The method includes the following steps.

At step S100, waveforms of acceleration signals and waveforms of excitation signals of two devices are acquired, respectively. In this embodiment, the evaluation of the vibrating sensation similarity of the device is converted into the calculation of the similarity of the corresponding acceleration, and the acceleration signal that causes the corresponding device to vibrate can be detected by using a corresponding detection device or module.

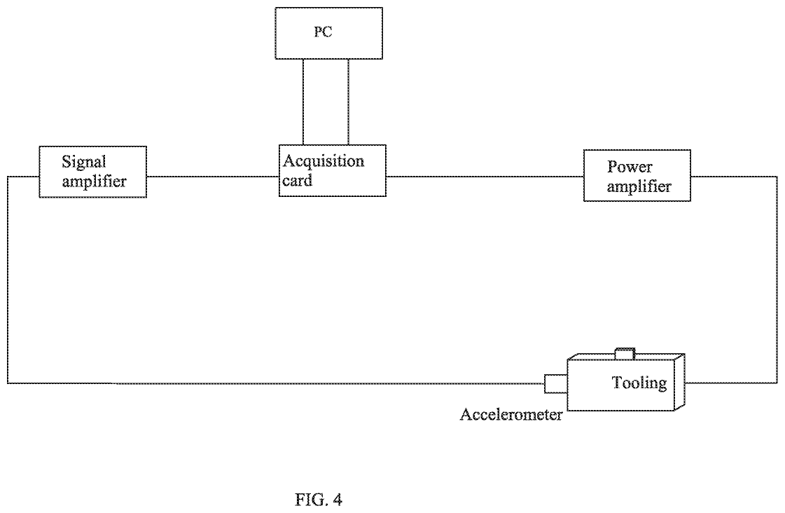

In the actual application, a vibration acceleration is generally used to describe the vibrating sensation of a motor or an actuator; thus, in evaluating the vibrating sensation similarity, it is necessary to first measure the acceleration waveform of the device such as the motor or actuator. FIG. 4 illustrates a hardware unit for implementing a method for measuring the acceleration of the motor by an accelerometer according to one embodiment, through which the acceleration waveform of the motor in a vibration shaft system can be acquired. As shown in FIG. 4, the hardware unit includes a Personal Computer (PC), an acquisition card, a signal amplifier, a power amplifier, a tooling, and an accelerometer used to detect the vibration of the tooling. The PC sends a control signal to the power amplifier through the acquisition card, and the amplified control signal is transmitted to the tooling to make the tooling vibrate. The accelerometer detects the vibration of the tooling in real time, the vibrating signal is amplified by the signal amplifier, and the amplified vibrating signal is transmitted to the PC through the acquisition card, so that the PC obtains the acceleration of the vibration of the tooling. In the experimental environment of FIG. 4, the acceleration signal measurement is conducted by using a tooling of 100 g and a motor. It is to be understood that, the method for measuring acceleration is not to be limited to the method provided by the present disclosure; other methods capable of measuring acceleration can be equally used.

At step S200, a method for calculating an acceleration similarity is determined according to need.

At step S300, a similarity between the acceleration signals of the two devices is obtained based on the waveforms of the acceleration signals and the waveforms of the corresponding excitation signals of the two devices according to the determined method for calculating an acceleration similarity.

At step S400, the vibrating sensation similarity between the two devices is obtained according to the similarity between the acceleration signals.

The method for calculating an acceleration similarity includes: a method for calculating a similarity between two acceleration signals from the perspective of numerical values and a method for calculating a similarity between two acceleration signals from the perspective of user experience.

Of course, it is also possible to judge whether two acceleration signals are similar to each other by manually observing waveform diagrams of the two acceleration signals. However, this method is based on human eye observation, and the result thereof is arguable.

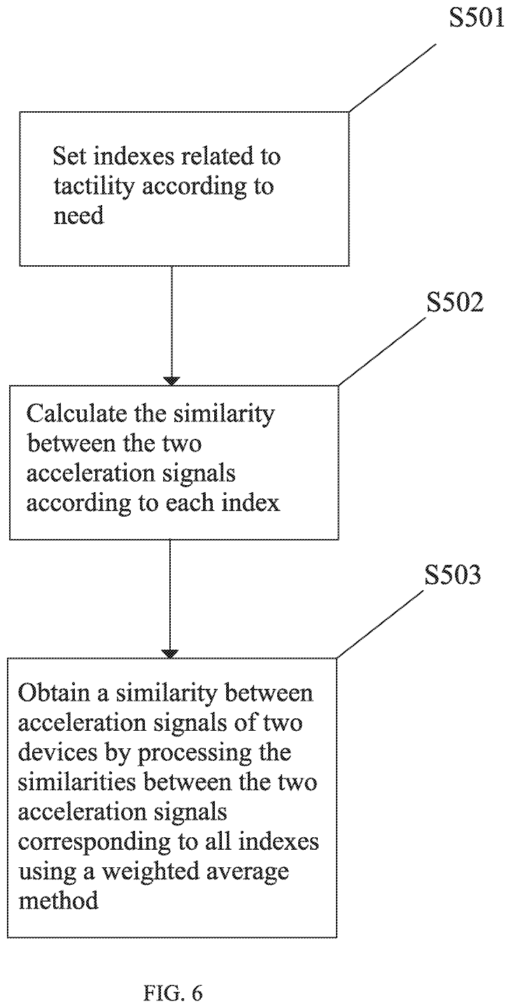

As shown in FIG. 6, the method for calculating a similarity between two acceleration signals from the perspective of user experience specifically includes the following steps.

At step S501, indexes related to user experience are set according to need.

At step S502, a similarity between the two acceleration signals is calculated according to each index.

At step S503, the similarity between the acceleration signals of the two devices is obtained by processing the similarities between the two acceleration signals corresponding to all indexes using a weighted average method.

The indexes are set by rules of thumb from the perspective of user experience. For example, the indexes include a difference in peak-to-peak values of acceleration in a signal phase, a difference in peak-to-peak values of acceleration in a residual vibration phase, a difference in signal duration, and a difference in the number of peak values in the signal phase. That is, the similarity between accelerations is calculated according to each index.

For example, step S402 further includes the following steps.

When the index is the difference in peak-to-peak values of acceleration in the signal phase, a similarity between peak-to-peak values of two acceleration waveforms in a signal phase of the excitation signal is calculated. The specific calculating method can be the same as described above and therefore its explanations are not repeated herein.

When the index is the difference in peak-to-peak values of acceleration in the residual vibration phase, the similarity between the peak-to-peak values of the acceleration waveforms after the excitation signal ends is calculated.

When the index is the difference in signal duration, a similarity between durations of the excitation signals of the two acceleration waveforms is calculated.

When the index is the difference in the number of peak values in the signal phase, a similarity between the numbers of local peak values of acceleration signals of the two acceleration waveforms is calculated.

On the other hand, the method for calculating a similarity between two acceleration signals from the perspective of numerical values refers to calculation from the perspective of pure numbers. In general, the similarity between the two acceleration signals is calculated by using a method of calculating the similarity between two curves.

There are various methods for calculating the similarity between two curves, including, for example, an EVM-based method, a Minkowski-distance-based method, and a Fletcher-similarity-based method.

### Second Embodiment

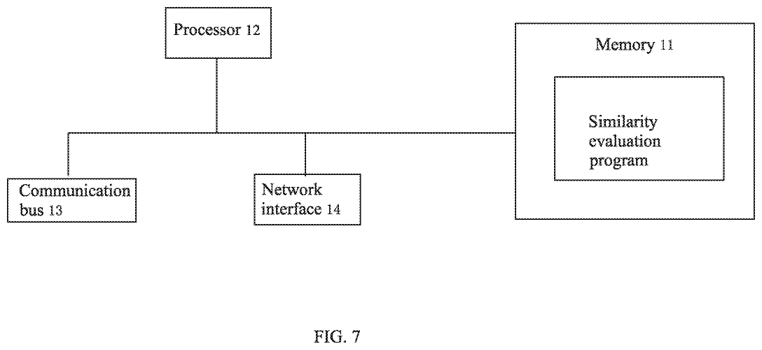

The present disclosure provides an apparatus for evaluating a vibrating sensation similarity. FIG. 7 is a circuit block diagram of an apparatus for evaluating a vibrating sensation similarity according to an embodiment of the present disclosure.

In this embodiment, the apparatus for evaluating a vibrating sensation similarity may be a PC, or a terminal device such as a smartphone, a tablet computer, or a portable computer. The apparatus for evaluating a vibrating sensation similarity includes at least a processor 12, a communication bus 13, a network interface 14, and a memory 11.

The memory 11 includes at least one type of readable storage medium, and the readable storage medium includes a flash memory, a hard disk, a multimedia card, a card-type memory (for example, SD or DX memory, etc.), a magnetic memory, a magnetic disk, an optical disk, and the like. In some embodiments, the memory 11 may be an internal storage unit of the apparatus for evaluating a vibrating sensation similarity, such as a hard disk of the apparatus for evaluating a vibrating sensation similarity. In other embodiments, the memory 11 may alternatively be an external storage device of the apparatus for evaluating a vibrating sensation similarity, for example, a plug-in hard disk, a smart media card (SMC), a secure digital (SD) card, a flash card, and the like equipped on the apparatus for evaluating a vibrating sensation similarity. Furthermore, the memory 11 may include both an internal storage unit and an external storage device of the apparatus for evaluating a vibrating sensation similarity. The memory 11 can be used not only to store application software installed in the apparatus and various types of data for evaluating a vibrating sensation similarity, for example, codes of a similarity evaluation program, but also to temporarily store data that has been or will be outputted.

In some embodiments, the processor 12 may be a central processing unit (CPU), a controller, a microcontroller, a microprocessor, or other data processing chips for running the program codes or processing data stored in the memory 11, for example, executing the similarity evaluation program.

The communication bus 13 is configured for connection and communication among these components.

The network interface 14 may optionally include a standard wired interface and a wireless interface (such as a WI-FI interface), and is generally used to establish a communication connection between the apparatus for evaluating a vibrating sensation similarity and other electronic devices.

Optionally, the apparatus for evaluating a vibrating sensation similarity may further include a user interface, the user interface may include a display, an input unit such as a keyboard, and the optional user interface may further optionally include a standard wired interface and a wireless interface. Optionally, in some embodiments, the display may be an LED display, a liquid crystal display, a touch-sensitive liquid crystal display, an OLED (Organic Light-Emitting Diode) touch device, or the like. The display may also be appropriately referred to as a display screen or a display unit, for displaying information processed in the apparatus for evaluating a vibrating sensation similarity and for displaying a visual user interface.

FIG. 7 only shows an apparatus for evaluating a vibrating sensation similarity having components 11-14 and a similarity evaluation program, and those skilled in the art can understand that the structure shown in FIG. 7 does not constitute a limitation on the apparatus for evaluating a vibrating sensation similarity, and the apparatus for evaluating a vibrating sensation similarity may include fewer or more components than shown, or combinations of some components, or have different component layouts.

In the embodiment of the apparatus for evaluating a vibrating sensation similarity shown in FIG. 7, the similarity evaluation program is stored in the memory 11. The following steps are implemented when the processor executes the similarity evaluation program stored in the memory 11:

step S100: acquiring waveforms of acceleration signals and waveforms of excitation signals of two devices, respectively;

step S200: determining, according to need, a method for calculating an acceleration similarity;

step S300: obtaining a similarity between the acceleration signals of the two devices based on the waveforms of the acceleration signals and the waveforms of the corresponding excitation signals of the two devices according to the determined method for calculating an acceleration similarity; and step S400: obtaining the vibrating sensation similarity between the two devices according to the similarity between the acceleration signals.

The method for calculating an acceleration similarity includes: a method for calculating a similarity between two acceleration signals from the perspective of numerical values and a method for calculating the similarity between two acceleration signals from the perspective of user experience.

Of course, it is also possible to judge whether two acceleration signals are similar to each other by manually observing waveform diagrams of the two acceleration signals. However, this method is based on human eye observation, and the result thereof is arguable.

The method for calculating a similarity between two acceleration signals from the perspective of user experience specifically includes the following steps.

At step S501, indexes related to user experience are set according to need.

At step S502, a similarity between the two acceleration signals is calculated according to each index.

At step S503, the similarity between acceleration signals of two devices is obtained by processing the similarities between the two acceleration signals corresponding to all indexes according to a weighted average method.

The indexes include a difference in peak-to-peak values of acceleration in a signal phase, a difference in peak-to-peak values of acceleration in a residual vibration phase, a difference in signal duration, and a difference in the number of peak values in the signal phase.

For example, step S402 further includes the following steps.

When the index is the difference in peak-to-peak values of acceleration in the signal phase, a similarity between peak-to-peak values of two acceleration waveforms in a signal phase of the excitation signal is calculated. The specific calculating method can be the same as described above and therefore its explanations are not repeated herein.

When the index is the difference in peak-to-peak values of acceleration in the residual vibration phase, the similarity between the peak-to-peak values of the acceleration waveforms after the excitation signal ends is calculated.

When the index is the difference in signal duration, a similarity between durations of the excitation signals of the two acceleration waveforms is calculated.

When the index is the difference in the number of peak values in the signal phase, a similarity between the numbers of local peak values of acceleration signals of the two acceleration waveforms is calculated.

### Third Embodiment

In addition, an embodiment of the present disclosure further provides a storage medium. The storage medium is a computer-readable storage medium with a similarity evaluation program stored thereon. The similarity evaluation program may be executed by at least one processors to implement the following operations:

step S100: acquiring waveforms of acceleration signals and waveforms of excitation signals of two devices, respectively;

step S200: determining, according to need, a method for calculating an acceleration similarity;

step S300: obtaining a similarity between the acceleration signals of the two devices based on the waveforms of the acceleration signals and the waveforms of the corresponding excitation signals of the two devices according to the determined method for calculating an acceleration similarity; and

step S400: obtaining the vibrating sensation similarity between the two devices according to the similarity between the acceleration signals.

The specific implementation of the storage medium of the present disclosure is substantially the same as the above embodiments of the method and the apparatus for evaluating a vibrating sensation similarity, which therefore is not described here in detail.

Although the disclosure is described with reference to one or more embodiments, it will be apparent to those skilled in the art that various modifications and variations can be made to the disclosed structure and method without departing from the scope or spirit of the disclosure. In view of the foregoing, it is intended that the present disclosure cover modifications and variations of this invention provided they fall within the scope of the following claims and their equivalents.

What is claimed is:

1. A method for evaluating a vibrating sensation similarity, comprising:
acquiring waveforms of two acceleration signals and waveforms of two excitation signals corresponding to the two acceleration signals, respectively; and
based on the waveforms of the two acceleration signals and the waveforms of the corresponding excitation signals, calculating a similarity between the waveforms of the two acceleration signals by a method for calculating an acceleration similarity to thereby evaluate a vibrating sensation similarity of devices corresponding to the two acceleration signals according to the similarity between the waveforms of the two acceleration signals, the method for calculating an acceleration similarity comprising a method for calculating a similarity between the two acceleration signals from the perspective of numerical values and/or a method for calculating a similarity between the two acceleration signals from the perspective of user experience.

2. The method for evaluating a vibrating sensation similarity according to claim 1, wherein the method of calculating a similarity between the two acceleration signals from the perspective of user experience comprises:
setting indexes;
calculating a similarity between the two acceleration signals according to each index; and
calculating a similarity between the two acceleration signals corresponding to all indexes using a weighted average method.

3. The method for evaluating a vibrating sensation similarity according to claim 2, wherein the indexes comprise a difference in peak-to-peak values of acceleration in a signal phase, a difference in peak-to-peak values of acceleration in a residual vibration phase, a difference in signal duration, and a difference in the number of peak values in the signal phase.

4. The method for evaluating a vibrating sensation similarity according to claim 3, wherein calculating the similarity between the two acceleration signals according to all indexes comprises:
when the index is the difference in peak-to-peak values of acceleration in the signal phase, calculating a similarity between peak-to-peak values of the two acceleration waveforms in a signal phase of the excitation signal; and
when the index is the difference in peak-to-peak values of acceleration in the residual vibration phase, calculating a similarity between peak-to-peak values of the acceleration waveforms after the excitation signal ends.

5. The method for evaluating a vibrating sensation similarity according to claim 3, wherein calculating the similarity between the two acceleration signals according to all indexes further comprises:
when the index is the difference in signal duration, calculating a similarity between durations of the excitation signals of the two acceleration waveforms; and
when the index is the difference in the number of peak values in the signal phase, calculating a similarity between the numbers of local peak values of acceleration signals of the two acceleration waveforms.

6. The method for evaluating a vibrating sensation similarity according to claim 4, wherein calculating the similarity between the two acceleration signals according to all indexes further comprises:
when the index is the difference in signal duration, calculating a similarity between durations of the excitation signals of the two acceleration waveforms; and
when the index is the difference in the number of peak values in the signal phase, calculating a similarity between the numbers of local peak values of acceleration signals of the two acceleration waveforms.

7. The method for evaluating a vibrating sensation similarity according to claim 1, wherein the method of calculating a similarity between the two acceleration signals from the perspective of numerical values comprises calculating the similarity between the two acceleration signals according to a method of calculating the similarity between two curves.

8. The method for evaluating a vibrating sensation similarity according to claim 1, wherein the method of calculating the similarity between two curves comprises one of an EVM-based method, a Minkowski-distance-based method and a Fletcher-similarity-based method.

9. The method for evaluating a vibrating sensation similarity according to claim 8, wherein a calculation formula for the EVM-based method is as follows:
$$evm = \sqrt{\frac{{\sum }_{i = 1}^{n} {\vert {x}_{i} - {y}_{i} \vert}^{2}}{{\sum }_{i = 1}^{n} {\vert {x}_{i} \vert}^{2}}} \times 100 \% ,$$
where a similarity between the two curves is 1-evm.

10. An apparatus for evaluating a vibrating sensation similarity, comprising:
at least one processor; and
a memory in communication with the at least one processor, the memory storing a similarity evaluation program thereon, the similarity evaluation program being executable by the at least one processor to implement a method for evaluating a vibrating sensation similarity, the method comprising:
acquiring waveforms of two acceleration signals and waveforms of two excitation signals corresponding to the two acceleration signals, respectively; and
based on the waveforms of the two acceleration signals and the waveforms of the corresponding excitation signals, calculating a similarity between the waveforms of the two acceleration signals by a method for calculating an acceleration similarity to thereby evaluate a vibrating sensation similarity of devices corresponding to the two acceleration signals according to the similarity between the waveforms of the two acceleration signals, the method for calculating an acceleration similarity comprising a method for calculating a similarity between the two acceleration signals from the perspective of numerical values and/or a method for calculating a similarity between the two acceleration signals from the perspective of user experience.

11. The apparatus according to claim 10, wherein the method of calculating a similarity between the two acceleration signals from the perspective of user experience comprises:
setting indexes;
calculating a similarity between the two acceleration signals according to each index; and
calculating a similarity between the two acceleration signals corresponding to all indexes using a weighted average method.

12. The apparatus according to claim 11, wherein the indexes comprise a difference in peak-to-peak values of acceleration in a signal phase, a difference in peak-to-peak values of acceleration in a residual vibration phase, a difference in signal duration, and a difference in the number of peak values in the signal phase.

13. The apparatus according to claim 12, wherein calculating the similarity between the two acceleration signals according to all indexes comprises:
when the index is the difference in peak-to-peak values of acceleration in the signal phase, calculating a similarity between peak-to-peak values of the two acceleration waveforms in a signal phase of the excitation signal; and
when the index is the difference in peak-to-peak values of acceleration in the residual vibration phase, calculating a similarity between peak-to-peak values of the acceleration waveforms after the excitation signal ends.

14. The apparatus according to claim 12, wherein calculating the similarity between the two acceleration signals according to all indexes further comprises:
when the index is the difference in signal duration, calculating a similarity between durations of the excitation signals of the two acceleration waveforms; and
when the index is the difference in the number of peak values in the signal phase, calculating a similarity between the numbers of local peak values of acceleration signals of the two acceleration waveforms.

15. The apparatus according to claim 12, wherein calculating the similarity between the two acceleration signals according to all indexes further comprises:
when the index is the difference in signal duration, calculating a similarity between durations of the excitation signals of the two acceleration waveforms; and
when the index is the difference in the number of peak values in the signal phase, calculating a similarity between the numbers of local peak values of acceleration signals of the two acceleration waveforms.

16. The apparatus according to claim 10, wherein the method of calculating the similarity between two curves comprises one of an EVM-based method, a Minkowski-distance-based method and a Fletcher-similarity-based method.

17. The apparatus according to claim 16, wherein a calculation formula for the EVM-based method is as follows:
$$evm = \sqrt{\frac{{\sum }_{i = 1}^{n} {\vert {x}_{i} - {y}_{i} \vert}^{2}}{{\sum }_{i = 1}^{n} {\vert {x}_{i} \vert}^{2}}} \times 100 \% ,$$
where a similarity between the two curves is 1-evm.

18. A computer-readable storage medium having a similarity evaluation program stored thereon, the similarity evaluation program being executable by a processor to implement a method for evaluating a vibrating sensation similarity, the method comprising:
acquiring waveforms of two acceleration signals and waveforms of two excitation signals corresponding to the two acceleration signals, respectively; and
based on the waveforms of the two acceleration signals and the waveforms of the corresponding excitation signals, calculating a similarity between the waveforms of the two acceleration signals by a method for calculating an acceleration similarity to thereby evaluate a vibrating sensation similarity of devices corresponding to the two acceleration signals according to the similarity between the waveforms of the two acceleration signals, the method for calculating an acceleration similarity comprising a method for calculating a similarity between the two acceleration signals from the perspective of numerical values and/or a method for calculating a similarity between the two acceleration signals from the perspective of user experience.

19. The computer-readable storage medium according to claim 18, wherein the method of calculating a similarity between the two acceleration signals from the perspective of user experience comprises:
setting indexes;
calculating a similarity between the two acceleration signals according to each index; and
calculating a similarity between the two acceleration signals corresponding to all indexes using a weighted average method.

20. The computer-readable storage medium according to claim 19, wherein the indexes comprise a difference in peak-to-peak values of acceleration in a signal phase, a difference in peak-to-peak values of acceleration in a residual vibration phase, a difference in signal duration, and a difference in the number of peak values in the signal phase, and calculating the similarity between the two acceleration signals according to all indexes comprises:
when the index is the difference in peak-to-peak values of acceleration in the signal phase, calculating a similarity between peak-to-peak values of the two acceleration waveforms in a signal phase of the excitation signal;
when the index is the difference in peak-to-peak values of acceleration in the residual vibration phase, calculating a similarity between peak-to-peak values of the acceleration waveforms after the excitation signal ends;
when the index is the difference in signal duration, calculating a similarity between durations of the excitation signals of the two acceleration waveforms; and
when the index is the difference in the number of peak values in the signal phase, calculating a similarity between the numbers of local peak values of acceleration signals of the two acceleration waveforms.
